(19) United States
(12) Patent Application Publication
(10) Pub. No.: US 2009/0149290 A1
(43) Pub. Date: Jun. 11, 2009

(54) METHOD FOR CHARGING A BATTERY OF A HYBRID VEHICLE AT REST

(75) Inventors: Stefan Wallner, Mattsee (DE); Notker Amann, Friedrichshafen (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/327,949

(22) Filed: Dec. 4, 2008

(30) Foreign Application Priority Data
Dec. 5, 2007 (DE) 10 2007 055 708.8

(51) Int. Cl. F16H 57/08

(52) U.S. Cl. 475/149

(57) ABSTRACT

A method for charging a battery connected to an electric machine in a vehicle having an electrodynamic drive system including an electric machine and a planetary gearset. A crankshaft of the internal combustion engine is connected with a first element of the planetary gearset, the electric machine with a second element of the planetary gearset and a transmission input shaft with another element of the planetary gearset. A friction clutch detachably connects two elements of the planetary gearset, such that when the clutch is engaged, the planetary gearset runs in locked operation and when the internal combustion engine is running and the clutch is disengaged, a gear in the transmission is engaged to charge the battery via the combustion engine. The combustion engine drives the rotor of the electric machine with the transmission ratio of the planetary gearset.

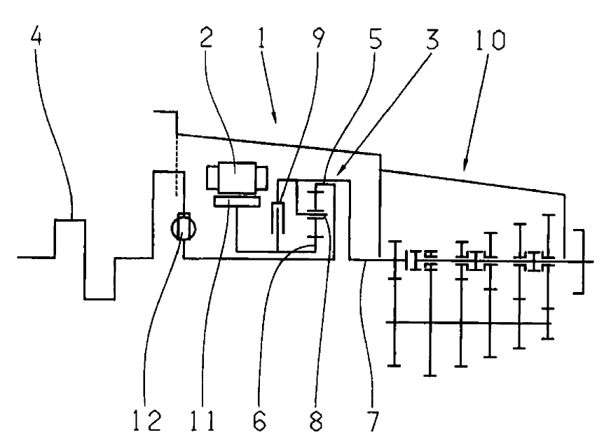

This application claims priority from German Application Serial No. 10 2007 055 708.8 filed Dec. 5, 2008.

### FIELD OF THE INVENTION

The present invention relates to a method for charging the battery connected to the electric machine of a vehicle having an electrodynamic drive system, in particular a parallel hybrid vehicle at rest.

### BACKGROUND OF THE INVENTION

From the prior art, hybrid vehicles that comprise a hybrid transmission are known. In addition to the internal combustion engine, they comprise an electric motor or electric machine. In serial hybrid vehicles, a generator is powered by the internal combustion engine and the generator supplies electrical energy to the electric motor, which drives the wheels. Furthermore, parallel hybrid vehicles are known, in which a summation of the torques of the internal combustion engine and at least one electric machine that can be connected with the internal combustion engine takes place. In such cases, the electric machines can be connected to the belt drive or to the crankshaft of the internal combustion engine. The torques produced by the internal combustion engine and/or the at least one electric machine are transmitted to the driven axle by a downstream transmission unit.

From the prior art, in the case of parallel hybrid vehicles, it is known to couple the electric machine not directly between the internal combustion engine and the transmission, but rather via a single-stage planetary gearset in a releasable manner between the combustion engine and the transmission, where an electro-dynamic drive system is formed.

For example, U.S. Pat. No. 6,805,648 B1 by the present Applicant, whose disclosure relating to the electrodynamic drive system is incorporated by reference into content of the present description and describes an electrodynamic drive system for a vehicle which comprises, between a drive engine and a main transmission, a planetary gearset that serves as a summation gear system and includes the three elements: a sun gear, a ring gear and a planetary gear carrier. In this, a first element of the planetary gearset is connected to the main transmission, a second element to the drive engine and a third element to at least one electric motor so that a wear-free starting element for the vehicle is formed.

U.S. Pat. No. 6,817,327 B2 by the present Applicant describes a method for starting an internal combustion engine of a vehicle equipped with an electrodynamic drive system, which comprises an electric machine and a planetary gearset between the internal combustion engine and a main transmission with an input shaft.

In this case the ring gear of the planetary gearset is connected in a rotationally fixed manner to the crankshaft of the internal combustion engine via a damping device and the carrier of the planetary gearset can be releasably connected to the rotor of the electric machine, which is connected in a rotationally fixed manner with the sun gear of the planetary gearset, by way of a friction clutch. The friction clutch serves as a bridging clutch of the planetary gearset since, when the friction clutch is engaged, the planetary gearset is locked.

In addition, the carrier of the planetary gearset is connected to the input shaft of the main transmission and the input shaft can be releasably coupled, via a brake, to a transmission housing.

Usually, in vehicles having an electrodynamic drive system, for example parallel hybrid vehicles, when the vehicle is at rest with its internal combustion engine running, the electrical energy for the main electrical system, for secondary consumers, etc., is produced by the electric machine.

The purpose of the present invention is to Indicate a method for charging a battery connected to the electric machine in a vehicle comprising an electrodynamic drive system, in particular a parallel hybrid vehicle at rest. The implementation of which can quickly charge the battery.

### SUMMARY OF THE INVENTION

Accordingly, a method is proposed for charging a battery connected to the electric machine in a vehicle comprising an electrodynamic drive system, in particular a parallel hybrid vehicle at rest, such that when the combustion engine of the vehicle is running, the bridging clutch of the planetary gearset is disengaged, a gear in the transmission of the vehicle is engaged and the battery is charged by the combustion engine.

In this case, the electrodynamic drive system comprises an electric machine and a planetary gearset that serves as a summation gear system, such that the crankshaft of the internal combustion engine of the vehicle is connected with a first element of the planetary gearset, the electric machine with a second element of the planetary gearset and the transmission input shaft with a further element of the planetary gearset. In addition, a friction clutch that serves as a bridging clutch is provided, which connects two elements of the planetary gearset to one another in a releasable manner, such that in the engaged condition of the clutch, the planetary gearset runs in locked operation.

Thanks to the concept, by way of the transmission ratio of the planetary gearset (the planetary gearset is not locked) the speed of the electric machine is raised in a controlled manner while the combustion engine is running at very low speeds so that the overall efficiency is increased advantageously.

### BRIEF DESCRIPTION OF THE DRAWING

The invention will now be described, by way of example, with reference to the accompanying drawing in which:

The sole FIGURE shows an electrodynamic drive system and its arrangement.

### DETAILED DESCRIPTION OF THE INVENTION

An electrodynamic drive system 1, shown in sole FIGURE, is arranged between the internal combustion engine (not shown) of the vehicle and a vehicle's transmission 10, which is preferably made as a change-speed transmission. The electrodynamic drive system 1 comprises an electric machine 2 and a planetary gearset 3 that serves as a summation gear system.

As can be seen from the FIGURE, a crankshaft 4 of the vehicle's combustion engine is connected, via a damping device 12, to a ring gear 5 of the planetary gearset 3, a rotor 11 of the electric machine 2 is connected to a sun gear 6 of the planetary gearset 3 and a transmission input shaft 7 is connected to a carrier 8 of the planetary gearset 3. In addition, a friction clutch 9 that serves as a bridging clutch is provided, which connects the sun gear 6 and the carrier 8 of the planetary gearset 3 releasably with one another so that when this clutch 9 is engaged the planetary gearset 3 runs in locked operation.

According to the invention, when the vehicle's combustion engine is running and the bridging clutch 9 of the planetary gearset 3 is disengaged, a gear is engaged in the transmission 10, where the combustion engine drives the rotor 11 of the electric machine 2 with the transmission ratio of the planetary gearset so that the battery connected to the electric machine 2 is charged.

Thus, the speed of the electric machine 2 is raised while the combustion engine is operated at very low speeds so that the overall efficiency is advantageously increased. In this case, the kinetic energy, produced by the combustion engine when it is idling, is put to good use.

### REFERENCE NUMERALS

1 electrodynamic drive system
2 electric machine
3 planetary gearset
4 crankshaft
5 ring gear
6 sun gear
7 transmission input shaft
8 carrier
9 friction clutch
10 transmission
11 rotor
12 damping device

1-2. (canceled)

3. A method for charging a battery connected to an electric machine in a parallel hybrid vehicle at rest which comprises an electrodynamic drive system (1) including the electric machine (2) and a planetary gearset (3), a crankshaft (4) of an internal combustion engine of the vehicle being connected with a first element (5) of the planetary gearset (3), the electric machine (2) being connected with a second element (6) of the planetary gearset (3) and a transmission input shaft (7) being connected with a third element (8) of the planetary gearset (3), and a friction clutch (9), which connects two of the first element (5), the second element (6) and the third element (8) of the planetary gearset (3) in a releasable manner such that, when the friction clutch (9) is engaged, the planetary gearset (3) operates in blocked condition, the method comprising the steps of:
disengaging the friction clutch (9) of the planetary gearset (3) while the internal combustion engine of the vehicle is operating; and
engaging a gear of the transmission (10) such that the combustion engine drives a rotor (11) of the electric machine (2) with a transmission ratio of the planetary gearset (3) and charges the battery.

4. The method according to claim 3, further comprising the steps of:
connecting the crankshaft (4) of the combustion engine, via a damping device (12), to the first element which is a ring gear (5) of the planetary gearset (3);
connecting the rotor (11) of the electric machine (2) to the second element which is a sun gear (6) of the planetary gearset (3);
connecting the transmission input shaft (7) to the third element which is a carrier (8) of the planetary gearset (3); and
connecting the sun gear (6) and the carrier (8) of the planetary gearset (3) with the friction clutch (9) in a releasable manner.

5. A method for charging a battery coupled to an electric machine (2) in a parallel hybrid vehicle having an electrodynamic drive system (1), when an internal combustion engine is operating and the vehicle is at rest, the method comprising the steps of:
coupling a crankshaft (4) of the internal combustion engine to a ring gear (5) of the planetary gearset (3) via a damping device (12);
coupling a rotor (11) of the electric machine (2) to a sun gear (6) of the planetary gearset (3);
coupling a carder (8) of the planetary gearset (3) to an input shaft (7) of a transmission (10) of the vehicle;
enabling releasable coupling between the sun gear (6) of the planetary gearset (3) and the carrier (8) of the planetary gearset (3), via a clutch (9), such that when the clutch (9) is engaged, the sun gear (6) of the planetary gearset (3) and the carrier (8) of the planetary gearset (3) are fixed with respect to each other; and
driving the rotor (11) of the electric machine (2) with the internal combustion engine at a transmission ratio of the planetary gearset (3) by disengaging the clutch (9) and engaging a gear in the transmission (10) of the vehicle to charge the battery coupled to the electric machine (2).

6. A method for charging a battery connected to an electric machine in a parallel hybrid vehicle at rest which comprises an electrodynamic drive system (1) including the electric machine (2) and a planetary gearset (3), a crankshaft (4) of an internal combustion engine of the vehicle being connected with a ring gear (5) of the planetary gearset (3), the electric machine (2) being connected with a sun gear (6) of the planetary gearset (3) and a transmission input shaft (7) being connected with a carrier (8) of the planetary gearset (3), and a friction clutch (9), which connects two of the ring gear (5), the sun gear (6) and the carrier (8) of the planetary gearset (3) in a releasable manner such that, when the friction clutch (9) is engaged, the planetary gearset (3) operates in blocked condition, the method comprising the steps of:
disengaging the friction clutch (9) of the planetary gearset (3) while the internal combustion engine of the vehicle is operating; and
engaging a gear of the transmission (10) such that the combustion engine drives a rotor (11) of the electric machine (2) with a transmission ratio of the planetary gearset (3) and charges the battery.
